(19) United States
(12) Patent Application Publication
(10) Pub. No.: US 2002/0104816 A1
(43) Pub. Date: Aug. 8, 2002

(54) Single-piece nipple to fit various beverage containers

(76) Inventors: Jon Feldman, Tucson, AZ (US); Gregory Ogden, Tucson, AZ (US)

Correspondence Address: Deborah Blyveis, Blrdwell Janke & Durando, PLC, Suite 1400, 1100 SW 6th Avenue, Portland, OR, 97204, US

(21) Appl. No.: 10/112,005

(22) Filed: Mar. 29, 2002

(51) Int. Cl. A61J 11/00; A61J 9/00

(52) U.S. Cl. 215/11.1

(57) ABSTRACT

A single-piece nipple to fit various sized beverage containers. The nipple fits over and seals to the top of standard water, juice, or soda containers that are available in supermarkets and other stores. The nipple enables children to drink directly from these containers without having to transfer the liquid to a bottle that is specially designed for children. The nipple includes a protuberance that is supported by a flexible base that has a wall for placement around a container mouthpiece. An aperture extends from the wall out through the protuberance creating a passage for liquid to flow from the container into the child's mouth. An attachment portion extends inwardly from the wall to seal the base to the mouthpiece of the container.

### FIELD OF THE INVENTION

This invention relates to a single-piece nipple adapter, particularly for attaching to various sized beverage containers so that children of various ages can drink therefrom.

### BACKGROUND OF THE INVENTION

Nipples that are used with standard infant bottles are generally attached to the bottle with a separate threaded collar. The bottle ordinarily has a wide-mouthed opening. After the bottle has been filled, the nipple is placed over the opening. The collar is then placed over the nipple and is threaded onto the bottle to hold the nipple in place. These nipples are limited in that they can only be used with a standard wide-mouth bottle. There are situations in which a child wants to drink water or juice, and a standard bottle is not available; or the child does not want to drink from a standard bottle, but can not yet drink without spilling from a standard water or juice container that is sold in stores. The nipples that are used with these standard baby bottles will not fit on the standard water or juice containers.

U.S. Pat. Nos. 5,573,507 and 5,688,238 to Moser et al. disclose a nipple system that can be used with a conventional baby bottle, or with another sized container when the nipple is utilized in conjunction with a straw. The nipple has a flexible upper portion that fits into the infant's mouth and a rigid lower portion that attaches to a baby bottle with a threaded collar in the conventional method. The nipple can also attach to a straw so that it can be used to drink from other types of containers. A disadvantage of this device is that the nipple attaches to the straw that is projecting upward from the container whose top is often open. Therefore, if the child turns the container or drops it, the liquid in the container is spilled.

U.S. Pat. No. 6,032,810 to Meyers et al. disclose a one-piece nipple and collar combination that includes a nipple that is molded over a rigid collar that has threads for attaching to a bottle or container. The one-piece nipple and collar can be made of different sizes to accommodate different size containers. Conventional water, juice and soda containers have tops with small variations in size. A disadvantage of this device is that the collar portion is rigid so that different size nipple and collar devices must be carried to accommodate for these small variations. Carrying a number of these devices is bulky and trying different sizes to fit the various containers is time consuming.

Therefore, there is a need to provide a single-piece nipple that fits various beverage containers of different sizes and that covers the top of the container so that liquid is not spilled if the bottle is turned or dropped.

### SUMMARY OF THE INVENTION

The single-piece nipple to fit various sized beverage containers of the present invention solves the aforementioned problems and meets the aforementioned needs by providing a single-piece flexible nipple that fits over and seals the top of standard water, juice, or soda containers that are available in supermarkets and other stores. The nipple enables children to drink directly from these containers without having to transfer the liquid to a bottle that is specially designed for children.

The nipple includes a protuberance that is supported by a flexible base that has a wall for placement around a container mouthpiece. An aperture extends from the wall out through the protuberance creating a passage for liquid to flow from the container into the child's mouth. An attachment portion extends inwardly from the wall to seal the base to the mouthpiece of the container.

The foregoing and other objects, features, and advantages of the invention will be more readily understood upon consideration of the following detailed description of the invention, taken in conjunction with the accompanying drawings.

### BRIEF DESCRIPTION OF THE DRAWINGS

FIG. 1 is a first embodiment of a single-piece nipple according to the present invention.

FIG. 2 is a second embodiment of a single-piece nipple according to the present invention.

FIG. 3 is a third embodiment of a single-piece nipple according to the present invention.

FIG. 4 is a view of the single-piece nipple of FIG. 3 showing a retaining member in dashed lines.

FIG. 5 is a fourth embodiment of a single-piece nipple according to the present invention.

FIG. 6A shows a side view of a retaining member and a safety protrusion molded as a single-piece.

FIG. 6B is top view of FIG. 6A.

FIG. 7 is a fifth embodiment of a single-piece nipple according to the present invention.

FIG. 8 is a sixth embodiment of a single-piece nipple according to the present invention.

FIG. 9 is a view of the single-piece nipple of FIG. 8 sealed to the mouthpiece of a container.

### DETAILED DESCRIPTION OF THE INVENTION

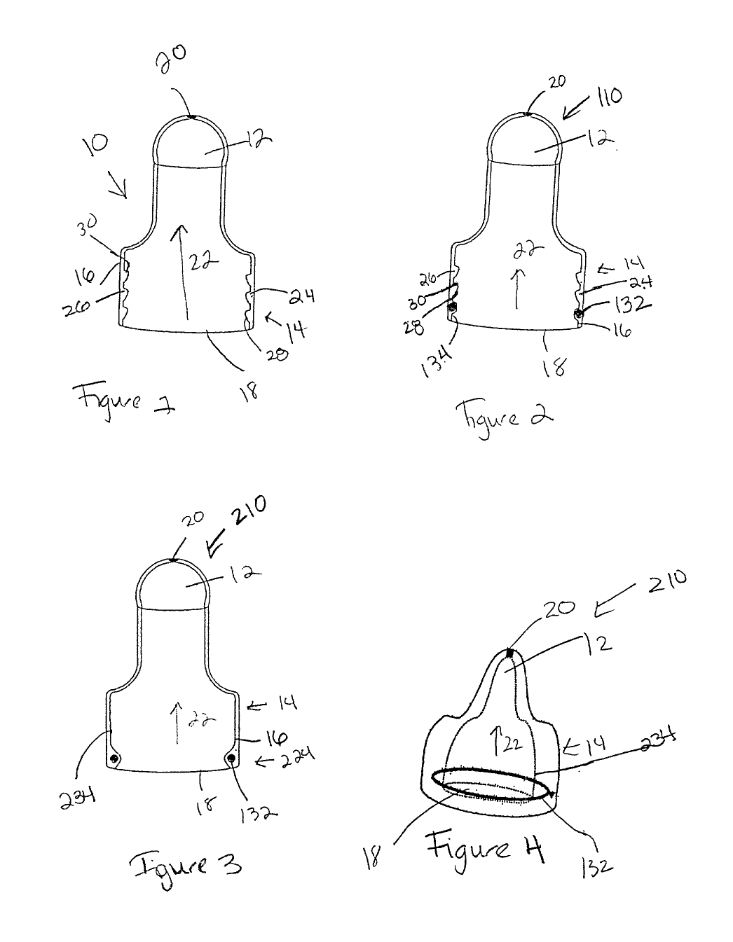

A first embodiment of a single-piece nipple 10 according to the present invention is shown in FIG. 1. The nipple 10 includes a protuberance 12 for insertion into a child's mouth. The protuberance 12 is supported by a flexible base 14 having a wall 16 that is placed over a mouthpiece of a container or bottle. The protuberance 12 and the base 14 form a single-piece. An aperture 18 extends from the base 14 through an opening 20 in the protuberance 12, creating a passage 22 for liquid to flow from the container into the child's mouth.

The single-piece nipple 10 attaches to the mouthpiece of the container by an attachment portion 24 that extends inwardly from the base 14. When the nipple 10 is attached to the mouthpiece of the container, the attachment portion 24 forms a seal with the container so that liquid does not leak from the container if the container is turned or dropped. The attachment portion 24 includes one or more ridges 26 that fit between threads on the mouthpiece. The ridges 26 have a tapered leading edge 28 that easily slides over the ridges of the mouthpiece and an abrupt trailing edge 30 that secures the nipple 10 to the container, thus preventing the nipple from falling off. When an upward force is applied to the nipple 10, the abrupt leading edge 30 pushes against the threads of the container, preventing the nipple from being removed from the container. The nipple is removed by twisting, which is similar to the removal of the original container cap. A child would most likely not be able to remove the nipple.

The single-piece nipple shown in FIG. 1 is adapted to attach to the tops of conventional (e.g., 1 liter, 500 ml, or 12-16 oz.) screw-top plastic beverage containers. These types of containers typically have a mouthpiece that has an approximate diameter of 28.5 or 31 mm. The base 14 of the nipple 10 is flexible to account for the small variations in the size of the threaded mouthpiece. The nipple is formed from a flexible food-grade polymer such as latex, silicone (such as Food grade 2-part silicones), or synprene thermoplastic elastomer. However, other compatible materials can be used without departing from the principles of the invention. The thickness of the single-piece nipple will vary based on the material and the manufacturing techniques. The single-piece nipple can be injection molded, dipped, or manufactured by other methods. The nipple is shown in FIG. 1 as having a fairly standard configuration, but other configurations can be formed without departing from the principles of the invention. The protrusion 20 and the base 14, which includes the attachment portion 24, are formed as a single-piece so there is no need to fumble with a number of parts or look for a lost piece as is common with a nipple that has a separate attachment mechanism.

A second embodiment of a single-piece nipple 110 according to the present invention is shown in FIG. 2. The second embodiment is similar to the first embodiment and parts that are the same are given the same number and work in the same way. The single-piece nipple 110 has an attachment portion 24 that has ridges 26 with leading and trailing edges 28 and 30 that are like the attachment portion 24 in the first embodiment. In addition, the single-piece nipple 110 includes a retaining member 132 that surrounds the base 14 at the attachment portion 24, and that provides constricting pressure to the base 14 to hold the nipple 110 in place. The retaining member 132 is designed so that it is positioned to be below the threads on the mouthpiece of the container. The retaining member can be a spring, a band, an o-ring, or any other item that provides constricting pressure. The retaining member can be formed from metal, or if the container is to be micro-waved it can be formed of a plastic material.

A third embodiment of a single-piece nipple 210 according to the present invention is shown in FIG. 3. The third embodiment is similar to the second embodiment and parts that are the same are given the same number. The single-piece nipple 210 has a knob-like attachment portion 224 located near the aperture 18 in the nipple 210. The nipple 210 is similar to the second embodiment in that it has a retaining member 132 that provides constricting pressure to the base 14 to hold the nipple 210 in place. However, the single-piece nipple 210 of the third embodiment does not have the ridges of the second embodiment.

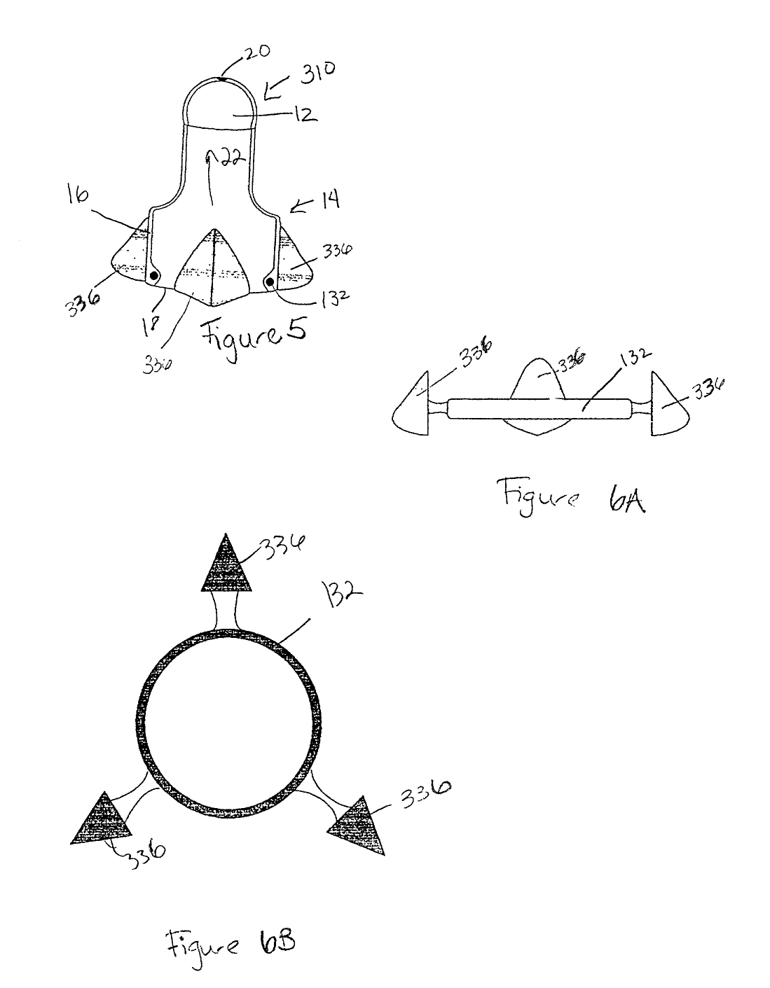

FIG. 4 shows the retaining member 132 as being ring-shaped, but other shapes that provide enough constricting pressure may be used without departing from the principles of the invention. The retaining member 132 is embedded in the wall 16 of the nipple 210 and rests below the threads of the mouthpiece of the container and above a bottom ridge (see 550 in FIG. 9) of the container. As an alternative, the retaining member 132 may be partially embedded in an inside wall 234 of the nipple 210, or the retaining member may be attached to the inside wall 234 without being embedded therein.

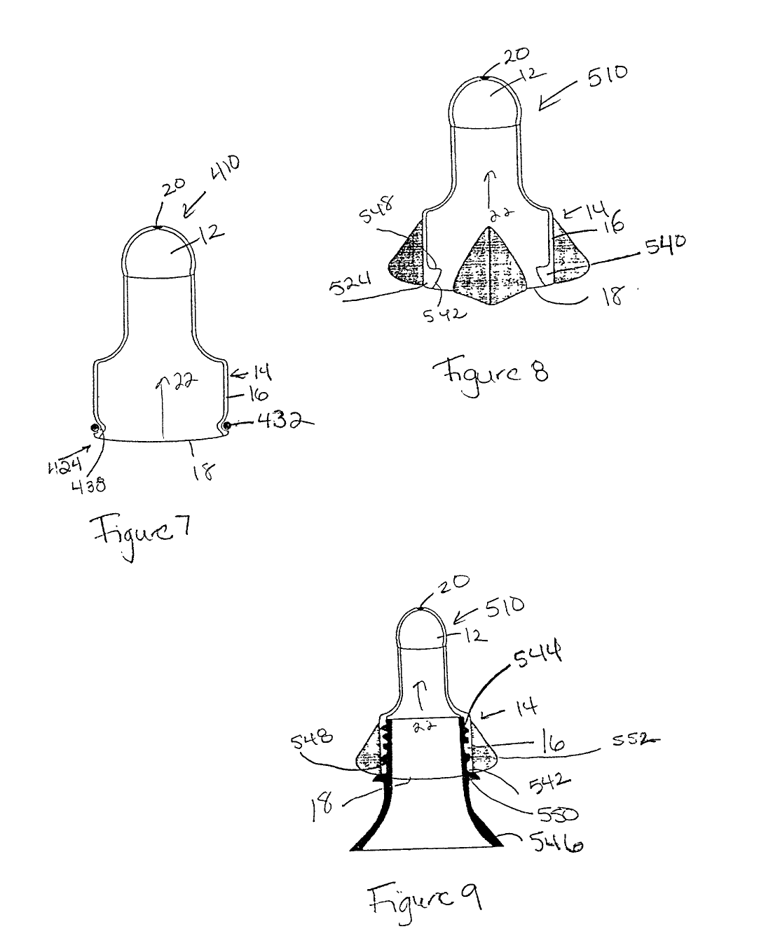

A fourth embodiment of a single-piece nipple 310 according to the present invention is a shown in FIG. 5. This embodiment is similar to the third embodiment in that a retaining member 132 provides constricting pressure to hold the nipple 310 on the container. In addition, the nipple has one or more wings or safety protrusions 336 that prevent the child from choking. The retaining member 132 and the wing 336 can be formed separately, or as shown in FIGS. 6A and 6B, they can be formed as a single-piece. The retaining member and the wings may be molded together, and then they may be over-molded by the protrusion 12 and the base 14. The safety protrusions 336 are shown as being wing-shaped, but other shapes that prevent children from choking can be used without departing from the principles of the invention. The nipple 310 can be removed from the container by pulling back on the safety protrusion 336. The safety protrusions are designed to comply with Infant Safety Guidelines pertaining to chocking. If a circle is drawn around the safety protrusions, the circle would have a diameter of at least 37 mm. The safety protrusions may also be used as a teething ring.

A fifth embodiment of a single-piece nipple 410 according to the present invention is shown in FIG. 7. The fifth embodiment is similar to the third embodiment and parts that are the same are given the same number. In this embodiment, an attachment portion 424 includes a groove 438 that is molded into the circumference of the base 14. After the nipple 410 is placed on the mouthpiece, a retaining member 432 such as a metal spring, band, or o-ring is placed over the top of the nipple 410 and inserted into the groove 432. The retaining member 432 provides constricting pressure to hold the nipple 410 on the container.

A sixth embodiment of the single-piece nipple 510 is shown in FIGS. 8-9. Instead of having an attachment portion 524 having internal ridges, the nipple 510 has a lip 540. The lip 540 has a bottom portion 542 that is angled to facilitate insertion over the mouthpiece 544 of the container 546, and a top portion 548 that is a flat trailing edge to prevent unwanted removal. As shown in FIG. 9, when the nipple 510 is placed on the mouthpiece of the container the bottom portion 542 abuts a bottom ridge 550 of the container and the top portion 548 abuts the bottom of the threads 552.

Although the safety protrusions are featured in two embodiments, they can be included in any of the embodiments. Moreover, the different retaining members can be interchanged and combined with one another. For example, the sixth embodiment could also include a retaining member. In addition, different size nipples can be formed in order to accommodate large variations in the size of the mouthpieces of the container.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

We claim:

1. A nipple for attachment to a beverage container having a threaded mouth piece, comprising:
a protuberance for insertion into a child's mouth; and
a flexible base for supporting said protuberance on the container, said base having a wall for placement around the container mouth piece and an aperture therethrough extending into said nipple and creating a passage for liquid to flow from the container into the child's mouth, said wall including an attachment portion that extends inwardly so as to engage the mouth piece of the container to secure said nipple to the container.

2. The nipple of claim 1, wherein said attachment portion comprises an internal ridge for engagement with the threads on the mouth piece of the container.

3. The nipple of claim 1, wherein said attachment portion comprises a plurality of internal ridges for insertion into respective spaces between threads.

4. The nipple of claim 2, wherein said ridge has a tapered leading edge in order to slide easily over the threads of the mouth piece.

5. The nipple of claim 2, wherein said ridge has an abrupt trailing edge to prevent said nipple from falling off the container.

6. The nipple of claim 1, further comprising a spring surrounding said base at said attachment portion, said spring contracting to firmly secure said nipple to the mouth piece.

7. The nipple of claim 6, wherein said base has an outer wall with a groove embedded therein at said attachment portion for receiving said spring.

8. The nipple of claim 6, wherein said spring is embedded in said wall of said base at said attachment portion, said spring contracting to firmly secure said nipple to the mouth piece.

9. The nipple of claim 1, wherein said attachment portion comprises a lip that has a top portion adapted to abut the threads on the container and a bottom portion adapted to abut a ridge situated below the threads in order to secure the nipple to the container.

10. The nipple of claim 1, further comprising a safety protrusion extending from said base to prevent the child from chocking on the nipple.

11. A method for enabling a child to drink from a beverage container having a threaded mouthpiece, comprising:
providing a nipple having a protuberance supported by a flexible base, an aperture extending from said base through said protuberance, and an attachment portion that extends inwardly so as to engage the mouthpiece; and
securing said nipple to the container by placing said base over the mouthpiece of the container while expanding said base so that said attachment portion engages the mouthpiece.

12. The method of claim 11, wherein said attachment portion engages the mouthpiece by fitting between the threads on the mouthpiece.

13. The method of claim 11, wherein said nipple includes a spring embedded in said base at said attachment portion and said step of securing comprises placing said base over the mouthpiece of the container so that said spring contracts and secures said base thereto.

14. The method of claim 11, wherein said step of securing further comprises placing a spring over said base at said attachment portion so that said spring contracts and secures said nipple to the mouthpiece.

15. The method of claim 11, wherein the attachment portion engages the mouthpiece by fitting between the threads and a ridge of the bottle.
